(19) United States
(12) Patent Application Publication
(10) Pub. No.: US 2015/0142924 A1
(43) Pub. Date: May 21, 2015

(54) METHOD FOR PROVIDING CONTENTS AND ELECTRONIC DEVICE USING THE SAME

(71) Applicant: Samsung Electronics Co., Ltd., Gyeonggi-do (KR)

(72) Inventor: Youngsub Lee, Gyeonggi-do (KR)

(21) Appl. No.: 14/549,362

(22) Filed: Nov. 20, 2014

(30) Foreign Application Priority Data
Nov. 21, 2013 (KR) 10-2013-0141845

(51) Int. Cl. H04L 29/06; G06F 17/30

(52) U.S. Cl. CPC H04L 65/60; G06F 17/30663
USPC 709/219

(57) ABSTRACT

Disclosed is a method of providing a content of an electronic device. The method includes, when an audio streaming service is requested to a server, transmitting user information of an electronic device. The method also includes receiving, from a server, a narration corresponding to the user information, and a recommended song list including songs mapped with the narration. The method also includes determining a reproduction priority by analyzing a weighted value of the user information of songs in the received recommended song list, and streaming and reproducing the songs according to the determined reproduction priority.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0141845, filed on Nov. 21, 2013, which is hereby incorporated by reference for all purposes as if fully set forth herein.

### TECHNICAL FIELD

The present disclosure relates to a method and an electronic device for providing music contents, to which narrations are input, of an electronic device.

### BACKGROUND

Currently, with the development of a digital technology, various electronic devices (e.g. a mobile communication terminal, a smartphone, a tablet Personal Computer (PC), and the like) which can perform communication and a personal information process have been commercialized. Such electronic devices provide a function of reproducing multimedia data which can execute an image or an audio, in addition to an inherent voice call service and various data transmission services.

In particular, users frequently use an internet audio streaming service by which the users can instantly listen to streamed sounds. Here, the internet sound source streaming service corresponds to a service by which the user can connect to the Internet and listen to a song in real time, in an electronic device such as a computer, which can access to the Internet.

Further, the electronic device provides a service which recommends a song matching with a user's situation (e.g. the number of times of song reproductions and/or user setting information internally managed by the electronic device) during the song reproduction. In general, the recommended service recommends a song based on a determination on user's taste performed using an order indicating how often the users listen to the song. In addition, when the song is reproduced, the electronic device provides a sound source service which displays only a singer's name, a song's title, an album jacket, lyrics, and the like without an additional description of the song during the song reproduction and continuously reproduces only the song.

### SUMMARY

However, an existing sound source streaming service continuously reproduces only a song, and a listener cannot know information on the song, such that there is inconvenience in that, when a person who hears a song for the first time wants to know about the song in detail, he/she should separately search for the information on the song. Further, there is no sufficient means by which a feedback can be received from a user when the reproduction of the song is terminated, such that it is difficult to recommend the song to another user.

To address the above-discussed deficiencies, it is a primary object to provide a method and an electronic device for providing a simple introduction, a story and a narration of a song directly input by a user before reproduction of the song.

An electronic device according to an embodiment of the present disclosure proposes a method and an electronic device for recommending a song matching with a user's situation by configuring a recommended item for the song to which the story and the narration are registered. That is, when the audio streaming service is requested, a recommended song list generated based on the configured recommended item can be provided to a user.

An aspect of the present disclosure is to provide a method of providing a content of an electronic device. The method includes, when an audio streaming service is requested to a server, transmitting user information of an electronic device. The method also includes receiving, from a server, a narration corresponding to the user information, and a recommended song list including songs mapped with the narration. The method also includes determining a reproduction priority by analyzing a weighted value of the user information of songs in the received recommended song list, and streaming and reproducing the songs according to the determined reproduction priority.

Another aspect of the present disclosure is to provide an electronic device for providing a content of an audio streaming service screen and a touch screen that displays the audio streaming service screen. The electronic device includes a Global Positioning System (GPS) reception unit that detects a location of the electronic device. The electronic device includes an audio processing unit that streams and reproduces a song when an audio streaming service is requested. The electronic device includes a controller that controls to display the audio streaming service screen on the touch screen, when the audio streaming service is requested to a server, transmits user information of the electronic device, receives a narration corresponding to the user information and a recommended song list including songs mapped with the narration, determines a reproduction priority by analyzing a weighted value of the user information of the songs in the received recommended song list, and controls to stream and reproduce the songs according to the determined reproduction priority.

Another aspect of the present disclosure is to provide a method of providing a content of a server. The method includes receiving user information from an electronic device; comparing the user information with the recommended item for the narration. The method also includes transmitting a narration coinciding with the user information and a recommended song list including songs mapped with the narration. The method also includes detecting a reproduction request of the songs in the recommended song list, transmitting the songs in the recommended song list in a streaming form to the electronic device, in response to the reproduction request of the songs.

An electronic device according to various embodiment of the present disclosure has an effect of transferring feeling by transferring, to another user, a narration including a story together with a song. For example, the electronic device can allow a user to know a behind story on the song as well as lyrics of the song in detail by transferring the narration mainly including a description of the song so as to understand the song deeply. Further, the electronic device can achieve an advertisement effect by transferring, to a user, an advertisement narration which advertises a product or a store. Further, the electronic device can make a sound source market more active by buying a song to which a story of a special day is input and transferring the song to a user. Further, a user can actively participate in the sound source service due to conversion of a unidirectional service mainly for song provision to a bidirectional service configured by user participation such as introduction of a story.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a configuration of an electronic device which executes an audio streaming service;

FIG. 2 illustrates a signal flow between the electronic device and a server;

FIG. illustrates is a signal flow diagram illustrating a signal flow between the electronic device and the server;

FIG. 4 illustrates a signal flow diagram illustrating a signal flow between the electronic device and the server;

FIG. 5 illustrates a signal flow between the electronic device and the server;

FIG. 6 illustrates a process of a method of providing contents;

FIG. 7 illustrates a process of an operation of registering a narration for contents;

FIG. 8 illustrates a process of an operation of reproducing contents;

FIGS. 9A and 9B illustrate views for describing the operation of reproducing contents; and

FIG. 10 illustrates a process of an operation of providing contents by the server 200.

### DETAILED DESCRIPTION

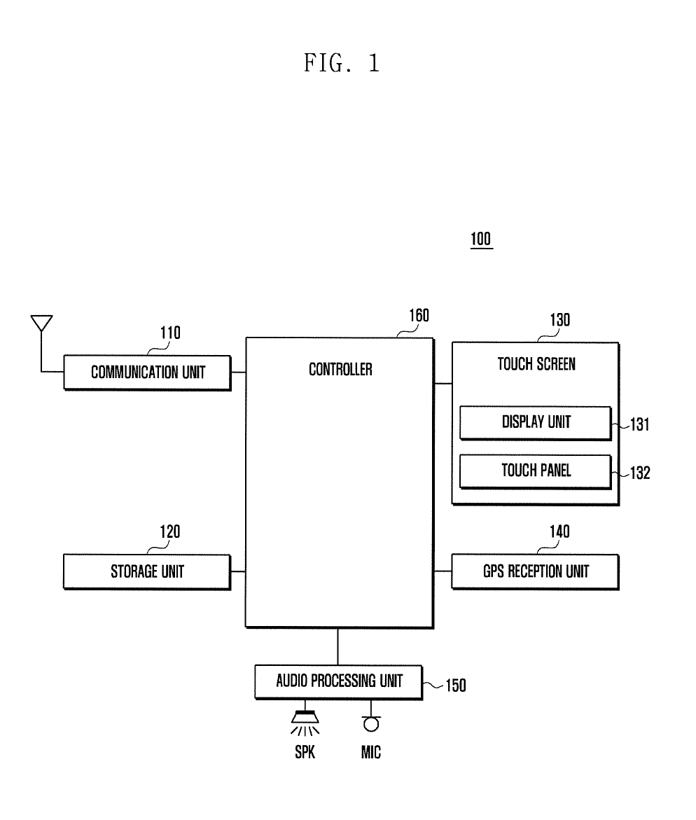

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Hereinafter, various embodiments will be described with reference to the accompanying drawings. It should be noted that the same elements will be designated by the same reference numerals although they are shown in different drawings. Further, a detailed description of a known function and configuration which may make the subject matter of the present disclosure unclear will be omitted. Hereinafter, it should be noted that only the descriptions will be provided that may help understanding the operations provided in association with the various embodiments of the present disclosure, and other descriptions will be omitted to avoid making the subject matter of the present disclosure rather unclear.

Exemplary embodiments of the present disclosure shown and described in this specification and the drawings correspond to specific examples presented in order to easily explain technical contents of the present disclosure, and to help comprehension of the present disclosure, but are not intended to limit the scope of the present disclosure. It will be apparent to those having ordinary knowledge in the technical field, to which the present disclosure pertains, that it is possible to practice other modified embodiments based on the technical idea of the present disclosure as well as the embodiments disclosed herein.

Before the detailed description, an electronic device 100 according to the present disclosure may be a mobile communication terminal, a smartphone, a tablet Personal Computer (PC), a hand-held PC, a Portable Multimedia Player (PMP), a Personal Digital Assistant (PDA), a notebook PC or the like.

In an embodiment of the present disclosure, a “narration” corresponds to a service which reproduces a simple introduction of a song and a story about the song before reproduction of the song. The story and the narration about the song are directly written, and information on when, where and by whom the song can be enjoyed is input, such that the song can be recommended to the corresponding user in the corresponding location at the corresponding time. When another user connects to the audio server and listens to the recommended song, the electronic device can first reproduce a song coinciding with information such as a location, a target, weather, and the like based on the recommended item. Further, when a story and a song wanted to be transferred to a specific person are determined and a time to be recommended is determined, when the specific person accesses to the sound source server at the time to be recommended, the song can be recommended together with the story.

Further, in the embodiment of the present disclosure, the “recommended item” implies an item for recommending a song to which a narration is registered to another user, and may include a time, a location, weather, a recommendation target, and the like. Further, songs to which the narrations are registered can be classified and stored with respect to each of the detailed matters of the “recommended item”. Further, in the embodiment of the present disclosure, “user information” may include current states of a user, i.e. a location of the user, a time when the user accesses to the sound source server, weather of the location of the user, and the like. When the “recommended item” and the “user information” are compared with each other, when an item of the “recommended item” and an item of the “user information” coincide with each other, a song corresponding to the item can be recommended to a user.

Here, the electronic device can configure a narration and recommended items of a song in which a user directly participates, to register the configured narration and the configured recommended items to a server. Here, the narration may be a story and/or feeling of a user for the corresponding song and a background description and/or an introduction of the corresponding song. Further, the recommended item may include a place, a location, a target (person who may listen to the song), weather, and the like in which/with whom the corresponding song can be listened to together with the narration, and one or more items of them may be recommended.

In the above state, when the sound source streaming service starts, the electronic device transmits information of the electronic device (i.e. at least one piece of information among user information, a location, a time, and the like) to the server. Then, the server transmits a sound source list (including a narration) corresponding to the information of the electronic device, to the electronic device. Then, the electronic device may reconfigure a reproduction sequence of the received sound source list in accordance with the user information, and may reproduce streaming song in the reconfigured reproduction sequence.

FIG. 1 illustrates a block diagram of a configuration of an electronic device 100 which executes an audio streaming service.

A first electronic device 101 and a second electronic device 102 have the same structure as that of the electronic device 100, such that the following description of the electronic device 100 is equal to the description of the first electronic device 101 and the second electronic device 102.

Referring to FIG. 1, the electronic device 100 according to the present disclosure may include a communication unit 110m, a storage unit 120, a touch screen 130, a Global Positioning System (GPS) reception unit 140, an audio processing unit 150, and a controller 160.

The communication unit 110 performs voice call, video call or data communication with an external device through a network. The communication unit 110 may be configured with a Radio Frequency (RF) transmitter that up-converts and amplifies a frequency of a signal to be transmitted, and an RF receiver that low-noise amplifies a received signal and down-converts a frequency of the received signal. Further, the communication unit 110 may include a modulator and a demodulator. The modulator and the demodulator may include functions of Code Division Multiple Access (CDMA), Wideband Code Division Multiple Access (WCDMA), Long Term Evolution (LTE), Wi-Fi, Wireless Broadband Internet (WiBro), Bluetooth, Near Field Communication (NFC), and the like. The communication unit 110 may be a mobile communication module, an Internet communication module and/or a short range communication module.

In particular, in an embodiment of the present disclosure, the communication unit 110 may request a server 200 to reproduce a song and may receive music contents provided from the server 200 using a streaming scheme, under a control of the controller 160. Further, the communication unit 110 may periodically collect location information, time information, weather information, and the like of the electronic device 100 while the music contents are streamed and may update and receive a music contents list according to the collected information, under the control of the controller 160.

The storage unit 120 may include a program memory for storing an operation program of the electronic device 100 and a data memory for storing data generated while a program is performed.

The touch screen 130 may be configured to be an integral type touch screen which includes a display unit 131 and a touch panel 132. The display unit 131 may display various screens according to use of the electronic device 100 under the control of the controller 160. The display unit 131 may be configured by one of a Liquid Crystal Display (LCD), an Organic Light Emitting Diode (OLED) and an Active Matrix Organic Light Emitting Diode (AMOLED). The touch panel 132 may be a composite touch panel including a hand touch panel for detecting a hand gesture and a pen touch panel for detecting a pen gesture.

In particular, in the embodiment of the present disclosure, the display unit 131 may display an audio streaming service screen. Further, the display unit 131 can display a song list coinciding with the recommended item configured for a song to which a narration is registered and a reproduction screen on which songs in the song list is reproduced, under the control of the controller 160.

The GPS reception unit 140 can acquire current location information of the electronic device 100 by receiving a GPS location signal.

The audio processing unit 150 is configured by a microphone MIC and a speaker SPK, and can convert an analog voice signal input from the microphone MIC into a digital voice signal to output the converted digital voice signal to the speaker SPK. Further, the audio processing unit 150 can output various audio signals generated by the electronic device 100 to the speaker SPK.

In particular, in the embodiment of the present disclosure, the audio processing unit 150 can reproduce the music contents in a streaming form under the control of the controller 160.

The controller 160 controls an overall operation of the electronic device 100 and a signal flow between internal components of the electronic device 100, processes data, and controls supply of electric power from a battery to the component.

In particular, in the embodiment of the present disclosure, the controller 160 can control the display unit 131 to display the audio streaming service screen. When it is requested to register a narration, the controller 160 can register a narration and a story to a song, and can configure and store a recommended item (e.g. a location, a time, a specific target, weather, and the like). Further, when it is requested to reproduce a song, the controller 160 can transmit user information to the server through the communication unit 110. In response to the request for reproducing a song, the server 200 can compare the user information with the recommended item to provide music contents corresponding to an item which is the same in both the user information and the recommended item, in a streaming form. In an example embodiment, the controller 160 can reproduce, through the audio processing unit 150, streaming music contents transmitted via the communication unit 110.

In addition, although the electronic device 100 may selectively further include components having additional functions, such as a camera module for photographing an image or a video, a broadcasting reception module for broadcasting reception, an input unit for input support based on a hard key, and the like, descriptions and illustrations of the components will be omitted.

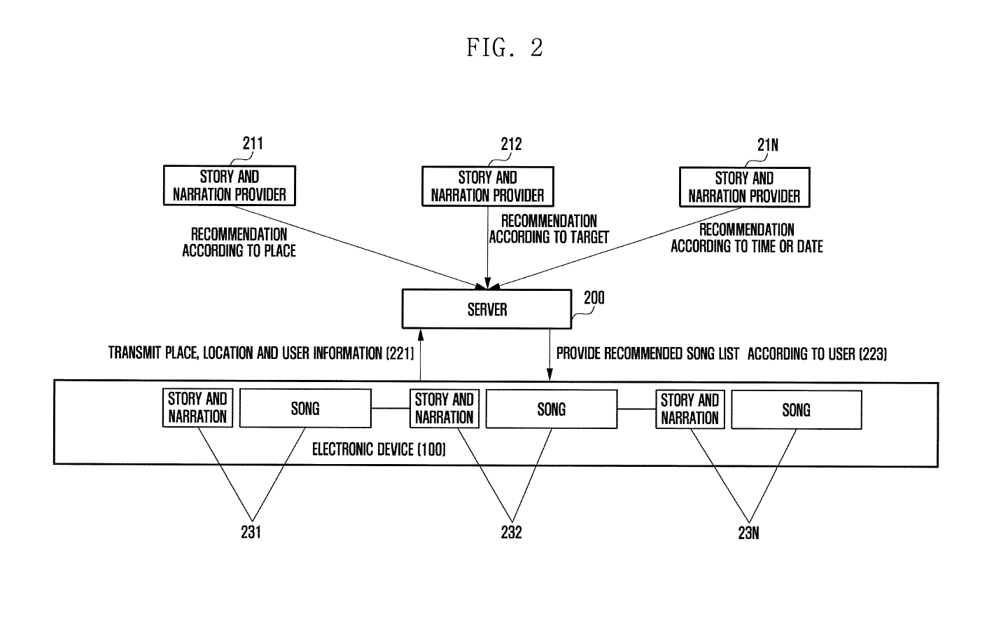

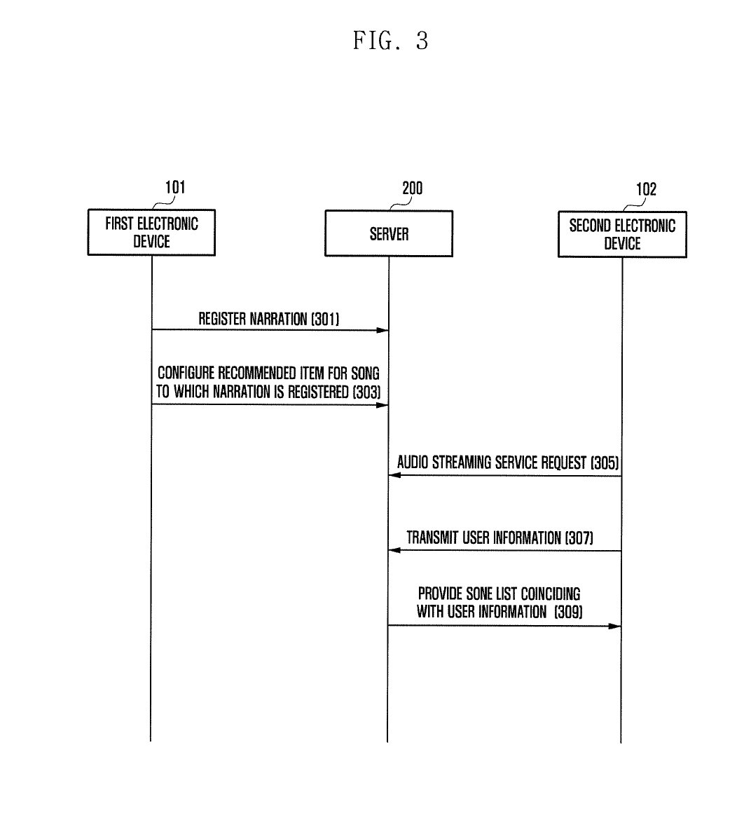

FIG. 2 illustrates a signal flow between the electronic device 100 and the server 200.

Referring to FIG. 2, the server 200 may receive, from story and narration providers 211 to 21N, a story and a narration which are input, and each story and narration provider 211 to 21N may configure a recommended item for a song to which a story and a narration are input, to recommend the configured recommended item to a user. The recommended item may include a location, a time, weather, a recommendation target, and the like, and the server 200 may classify and store songs with respect to the location, the time, the weather, and the recommendation target which are configured. The electronic device 100 may transfer, to the server 200, user information such as a place, a location, weather, the number of times of song reproductions, and the like, and the server 200 having received the user information through the communication unit 110 may compare the user information and the recommended item to provide, to a user, a story and a narration of an item which is the same in both the user information and the recommended item, and songs 231 to 23N corresponding to the story and the narration.

FIG. 3 illustrates a signal flow between the electronic device 100 and the server 200.

Referring to FIG. 3, in operation 301, a first electronic device 101 may register a story and a narration for a song, to the server 200. Further, in operation 303, the first electronic device 101 may configure a recommended item (e.g. a location, a time, weather, a recommendation target, and the like) for the song to which the story and the narration are registered and may transmit the recommended item to the server 200. In an example embodiment, the server 200 may classify and store the songs with respect to each recommended item.

A second electronic device 102 may request the server 200 to transmit an audio streaming service, in operation 305, and may transmit user information to the server 200, in operation 307. Here, the user information may include a current location of a user, a time at which the user accesses to a sound source server, weather information of a location of the user, and the like. In response to the request of the audio streaming service from the second electronic device 102, the server 200 may compare the user information with the recommended item to provide, to the second electrode device 102, a recommended song list coinciding with the user information, in operation 309.

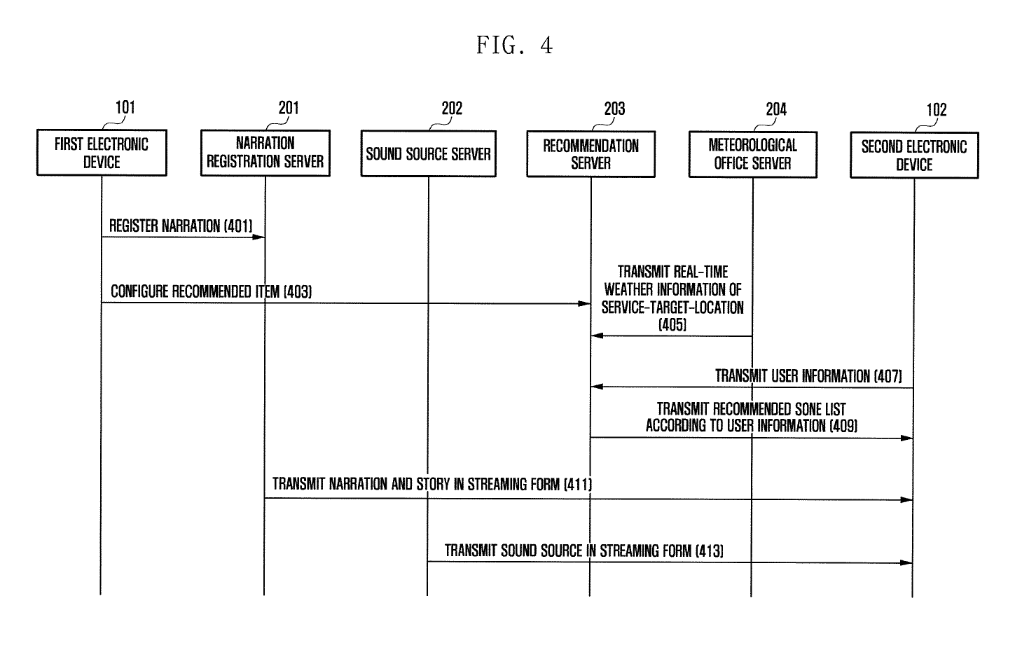

FIG. 4 illustrates a signal flow between the electronic device 100 and the server 200.

Referring to FIG. 4, in operation 401, the first electronic device 101 may register a story and a narration for a song, to a narration registration server 201. Further, in operation 403, the first electronic device 101 may configure a recommended item (e.g. a location, a time, weather, a recommendation target, and the like) for a song to which the story and the narration are registered and may transmit the recommended item to a recommendation server 203. Further, in operation 405, the recommendation server 203 may periodically receive real-time weather information of a service-target-location from a meteorological office server 204. Further, in operation 407, the second electronic device 102 may transmit user information to the recommendation server 203. Here, the user information may include a current location of a user, a time at which the user accesses to a sound source server, weather information of a location of the user, and the like. The recommendation server 203 may transmit, to the second electronic device 102, a recommended song list according to the received user information. Further, in operation 411, the narration registration server 201 may transmit, to the second electronic device 102, the narration and the story registered to a song, in a streaming form. Further, in operation 413, a sound source server 202 may transmit a song in a streaming form, to the second electronic device 102. That is, the second electronic device 102 may first listen to the narration and the story and may then listen to the song.

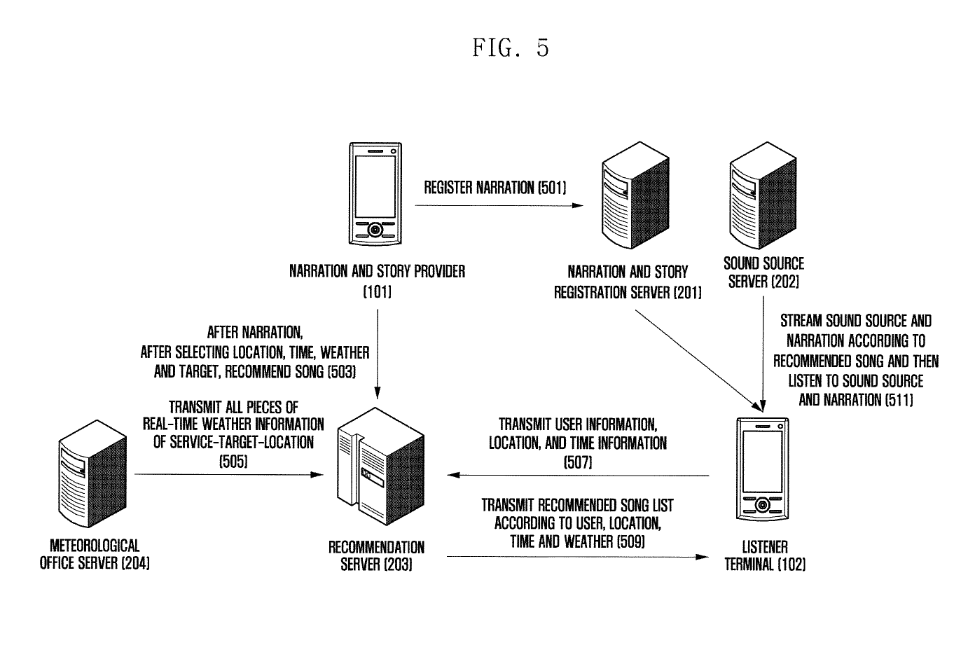

FIG. 5 illustrates a signal flow between the electronic device 100 and the server 200.

Referring to FIG. 5, an electronic device may include a narration and story provider 101 (i.e. a first electronic device), and a listener terminal 102 (i.e. a second electronic device), and a server may include a narration and story registration server 201, a sound source server 202, a recommendation server 203, and a meteorological office server 204.

The narration and story provider 101 corresponds to all of users joining a service, and may register a narration to the narration and story registration server 201, as indicated by reference numeral 501. Here, the narration and story registration server 201 may store the narration and the story and may transmit the story, the narration, and songs corresponding to the story and the narration in a streaming form, to the listener terminal 102 which wants the narration and the story. Further, the narration and story registration server 201 and the sound source server 202 are connected to each other in a link form, and the sound source server 202 may store a sound source to which the narration and the story are registered and may transmit, to a user, the narration and the story in a streaming form. That is, when the listener terminal 102 makes a request to reproduce recommended songs, the narration and story registration server 201 may transmit, to the listener terminal 102, the narration and the story in a streaming form, and the sound source server 202 may transmit, to the listener terminal 102, the sound source in a streaming form. The listener terminal 102 may listen to the narration and the story which are transmitted and the sound source corresponding to the narration and the story, as indicated by reference numeral 511. Further, the narration and story provider 101 may register the narration, configure a recommended item such as a location, a time, weather, a target, and the like, and then recommend songs to the recommendation server 203, as indicated by reference numeral 503. In an example embodiment, when the song is recommended, when a recommendation target is not joined in an unlimited streaming service, the song may be given as a gift. When the recommendation targets are random and there is a plurality of recommendation targets, the song may be recommended only to users who can reproduce the song. Further, the meteorological office server 204 may transmit real-time weather information of a service-target-location, to the recommendation server 203, as indicated by reference numeral 505. The listener terminal 102 may transmit user information (e.g. a location, time information, and the like), to the recommendation server 203, as indicated by reference numeral 507. Here, the recommendation server 203 may compare the user information with the recommended item configured by the narration and story provider 101 to generate a list of songs corresponding to an item which is the same in both the user information and the recommended item based on the comparison result. Here, when receiving the recommended song list from the recommendation server 203, the listener terminal 102 may determine a song reproduction sequence by calculating a weighted value according to the user information corresponding to the song in the recommended song list. Further, the listener terminal 102 may periodically receive a location thereof from the GPS reception unit 140, and when the location thereof is changed, the listener terminal 102 may update the recommended song list to be suitable for the changed situation (e.g. a location, weather, and the like) and may adjust the song reproduction sequence. Further, the listener terminal 102 may transmit, to the recommendation server 203, a feedback result for the sound source to which the narration and the story are registered, and the recommendation server 203 may store the feedback result.

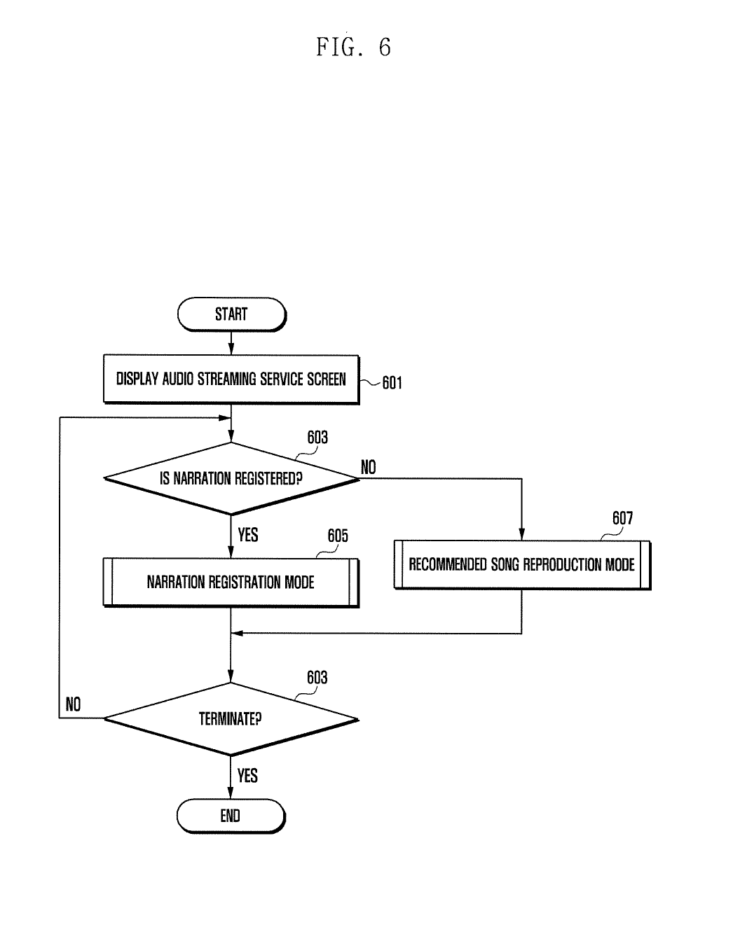

FIG. 6 illustrates a process of a method of providing contents.

Referring to FIG. 6, in operation 601, the controller 160 can control the display unit 131 to display the audio streaming service screen. Here, the audio streaming service may include an application (e.g. Melon, Bugs, and the like) and/or a music site which support reproduction of songs in real time during Internet connection. In operation 603, the controller 160 may determine whether the story and/or the narration for the song are registered, using the audio streaming service screen displayed on the display unit 131. When a command for registering the story and/or the narration for the song is generated, the controller 160 may detect the command, in operation 603, and may execute a narration registration mode, in operation 605. The narration registration mode corresponds to a mode in which the story and/or the narration (e.g. advertisement, celebration, education related contents, and the like) can be input, and corresponds to a mode in which an item for recommending the song to another user can be configured.

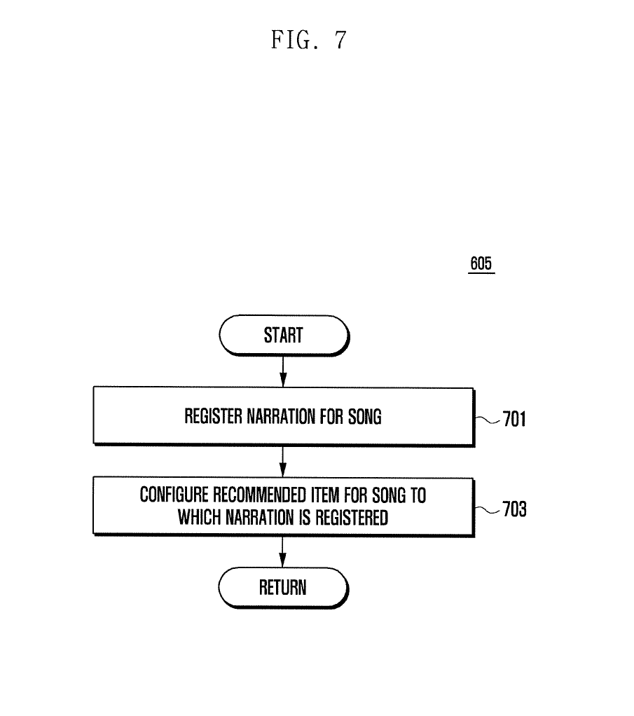

Detailed performance operations of operation 605 in FIG. 6 will be described with reference to FIG. 7.

FIG. 7 illustrates a process of an operation of registering a narration for contents.

Referring to FIG. 7, in operation 701, the controller 160 may register a narration for a song. Although the narration may include a narration relating to a memory of a user about the song, a narration for describing a history of the song, a narration for advertising some objects, a narration for celebrating someone's birthday, and the like, the narration according to the present disclosure is not limited thereto. A method of registering the narration may correspond to uploading the narration by directly inputting the narration through a microphone of the audio processing unit 160 or writing the story and the narration on the audio streaming service screen and then providing the written story and the written narration to a user through an automatic voice service provided by the server 200. Using the narration, a service to which feeling is added can be provided to a basic system that only reproduces a song. Further, the number of stories which the narration and story provider can make within one day is determined, and the number of stories for one song and for one person is also determined. When users want to register the story of which the number is larger than the determined number, a previously-made story could be deleted or additional charging may be used. In addition, the previously-recommended song may be deleted according to a selection of users, thereby preventing one person from excessively occupying the story system.

Next, in operation 703, the controller 160 may configure a recommended item for recommending a song, to which a narration is registered, to another user. The recommended item may include a time (e.g. morning, midday, evening, and the like), a location (e.g. school, sea, mountain, and the like), weather (e.g. sunny, rainy, cloudy, and the like), a recommendation target (e.g. teenagers, people in their twenties, specific targets, and the like), and the like, and the server 200 may compare the configured recommended item and the user information transmitted from the electronic device 100 to transmit a song list corresponding to an item which is the same in both the recommended item and the user information, to the electronic device 100.

Referring back to FIG. 6, when the command for registering the narration is not generated in operation 603, the controller 160 may execute a recommended song reproduction mode, in operation 607.

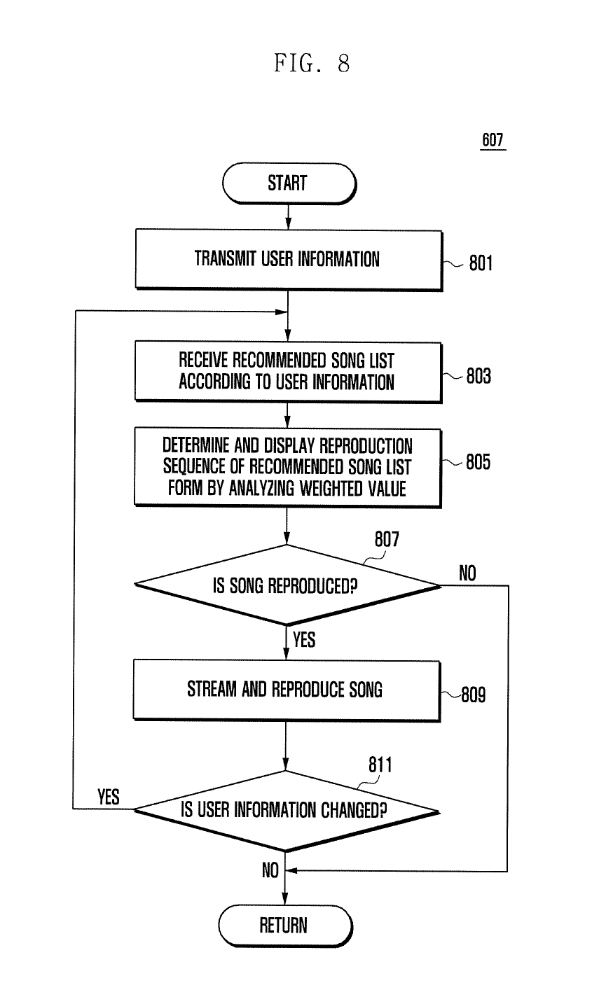

Detailed performance operations of operation 607 in FIG. 6 will be described with reference to FIG. 8.

FIG. 8 illustrates a process of an operation of reproducing contents.

Referring to FIG. 8, in operation 801, the controller 160 may transmit the user information to the server 200. Here, although the user information may include a current location of a user, a time when the user accesses to the sound source server, weather information of the current location of the user, the number of times of song reproductions internally managed by the electronic device 100 and/or the user setting information, the user information according to the present disclosure is not limited thereto. Next, in operation 803, the controller 160 may receive a recommended song list (including songs including narrations) according to the user information, from the server 200. Further, in operation 805, the controller 160 may analyze a weighted value based on the user information corresponding to each song to determine a priority (i.e. a song reproduction sequence) of the recommended song.

Here, the weighted value may be calculated by equations in Table (1), and a song to be preferentially reproduced may be determined according to the calculated weighted value.

TABLE 1
□□recommendation weighted value□□ x number by which
recommendation is given to itself
□□location weighted value□□ x □□□□□number of listeners
within designated range
□□time weighted value□□ x □□□□□set time
□□target weighted value□□ x □□□□□number of designated targets
□□weather weighted value□□ x □□□□□number of days when
weather of location thereof coincide
with
designated weather within 1 year
□only when weather condition coincide with each other, a song is
reproduced□
□□story estimation weighted value□□ x □□□□□story estimation score
Whether number of times of reproductions is zero during recent v time
period

For example, it is assumed that a user A recommends a location around Gangnamdaero as a place and uploads, to a sound source server, a narration of a brief introduction for a restaurant and a song thereof, in order to advertise the restaurant thereof. In an example embodiment, while walking on Gangnamdaero and using the sound source service, when a user B listens to the narration uploaded by the user A, a chance that the user B will visit the restaurant may increase. In this embodiment, the narration and the sound source may be recommended to all of users using the sound source server on Gangnamdaero, by increasing the location weighted value.

As another example, it is assumed that, in order to celebrate a birthday of a user D, a user C configures a school as a place and a lunch time as a time and then recommends a song while leaving a comment for celebrating the birthday. In an example embodiment, while using the sound source at the lunch time, the user D and students of the school listen to the story written by the user C, such that the user D and the students may know that today is the user D's birthday and may celebrate the user D's birthday. In this embodiment, the sound source may be recommended to users being using the sound source service at the lunch time in the school, by greatly increasing the time weighted value and the location weighted value. Even when not using the sound source service at the recommended location and/or the recommended time configured by the user C, the user D increases the time weighted value and the location weighted value, such that the user D transmits a message indicating that a music message arrives, to be connected to the sound source service, so as to enable the user C to listen to the sound source to which the narration recommended by the user C is registered.

As yet another example, it is assumed that a user E climbs Halla Mountain to see Baekrokdam to register a narration about his/her dream and passion, and configures a recommended location of a related song as the top of Halla Mountain, a recommended time of the related song as 10 years later, and a recommendation target of the related song as himself/herself. After 10 years, when the user E climbs to the top of Halla Mountain and wants to listen to a song, the user E will be able to listen to the song recommended by himself/herself 10 years earlier. In this embodiment, the song can be identified by increasing the weighted value of the time, the location, and the target, and the sound source cannot be recommended to another user by configuring the specific target as himself/herself, and can be recommended to only the user E.

As yet another example, it is assumed that a user F leaves a story for proposing to a user G who is his/her lover, and then recommends a song only to the user G who is a specific target. While randomly listening to songs, the user G can listen to the story and the song recommended by the user F. In this embodiment, the song can be recommended only to the user G by increasing the target weighted value.

As yet another example, a user H who is a music teacher determines that people lacks an understanding of classical music, and adds a narration about a background of music, a description of a composer, and an introduction of a story, to a classical music which he/she frequently enjoys and recommend the classical music. In an example embodiment, since a recommended item for the song is not configured, the song may be recommended to all of users using the sound source. While randomly listening to a song, people can listen to an explanation given by the user H and well understand the song frequently heard to in an advertisement and can give a high evaluation. Due to the high evaluation, the narration of the user H and the song recommended by the user H can be recommended to more people.

As yet another example, it is assumed that a user I records a rock song good for listening to during stormy weather and a story together with lightning and thunder which the user I currently watches and listens to, and recommends the story and the song for stormy weather. When stormy weather is coming, when the users using the sound source server listen to the recommended service song, the users can listen to the recommended song and the story recorded by the user I while listening to the thunder. In this embodiment, by greatly increasing the weather weighted value, when current weather coincides with specific weather, a specific song may be recommended to all of the users being using the sound source server.

As described above, the weighted value may be increased or decreased as the number of items which are the same in user information and a recommended item configured when a narration is registered is larger. That is, the weighted value may be differently configured every time.

Next, in operation 807, the controller 160 may determine whether to reproduce a song in the recommended song list displayed on the display unit 131. When it is determined to produce a song, the controller 160 may detect the determination in operation 807, and may reproduce the song in a streaming form in operation 809. Further, in operation 811, the controller 160 may determine whether the user information is changed. Here, the change of the user information may include situations where a change in a location of a user is detected, time passes, and weather is changed. When it is detected that the user information is changed, the controller 160 may branch off to operation 803, to receive the recommended song list generated according to the changed user information.

Referring back to FIG. 6, in operation 609, the controller 160 may determine whether a termination command is detected. When the termination command is generated, the controller 160 may terminate the audio streaming service. However, when the termination command is not generated, the controller may branch off to operation 603 to determine whether the narration is registered or whether the recommended song is reproduced.

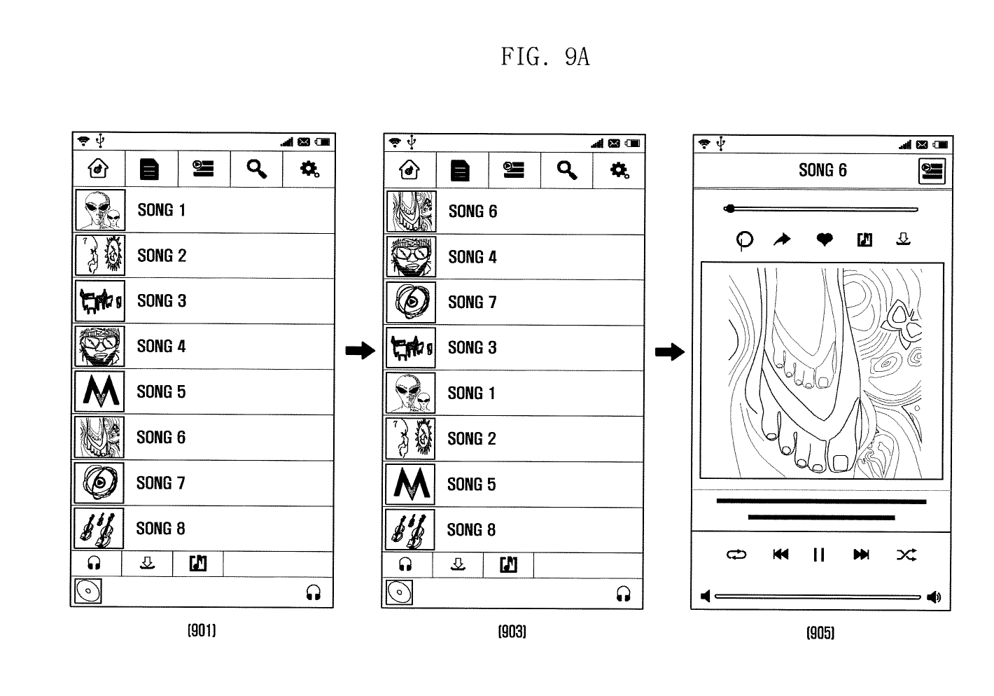

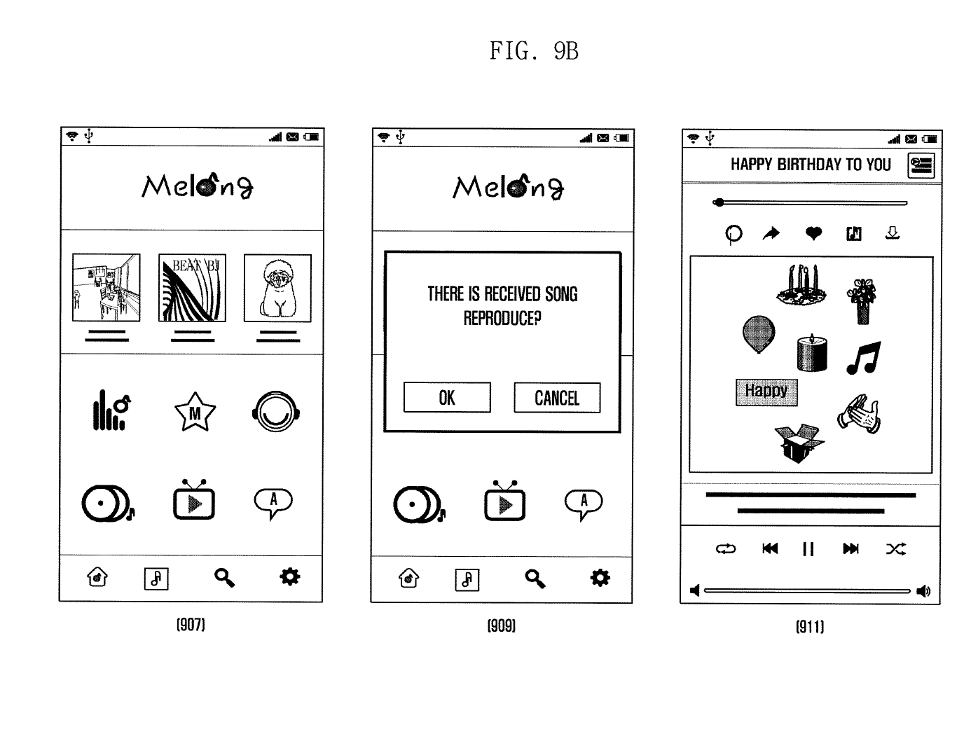

FIGS. 9A and 9B illustrate views for describing the operation of reproducing contents.

FIG. 9A illustrates a view for describing a process of determining a song priority by analyzing a weighted value of user information from a recommended song list received from the server and reproducing the song according to the determined song priority. Referring to FIG. 9A, it is assumed, as illustrated in a screen 901, that a recommended song list coinciding with user information is received from the server. The controller 160 may determine a reproduction priority of songs corresponding to the recommended song list by analyzing a weighted value of user information from the recommended song list illustrated in the screen 901. The weighted value may include a recommendation weighted value, a location weighted value, a target weighted value, a weather weighted value, a story evaluation weighted value, and the number of times of reproduction within a predetermined time period, and the weighted value may be designated to be higher as the number of the weighted values of the user information coinciding with the recommended item of the narration is larger. As illustrated in a screen 903, a reproduction sequence of the received recommended song list is formed in a line in order from a song having the highest weighted value, and as illustrated in a screen 905, the song having a higher production priority may be preferentially streamed and reproduced.

FIG. 9B illustrates a view for describing a method of configuring a specific target and recommending a song to the specific target.

Referring to FIG. 9B, as described above, it is assumed that the user C configures a recommendation target as the user D and a time as a lunch time, and recommends a birthday celebration song together with a comment “Happy birthday to you” to the user D. When the user D accesses to an audio streaming service screen illustrated in a screen 907 of FIG. 9B at a lunch time, a song is received from the user C, such that a popup window may be displayed as illustrated in a screen 909. When the user D selects “OK” on the popup window, the birthday celebration song may be streamed and reproduced together with the comment “Happy birthday to you”.

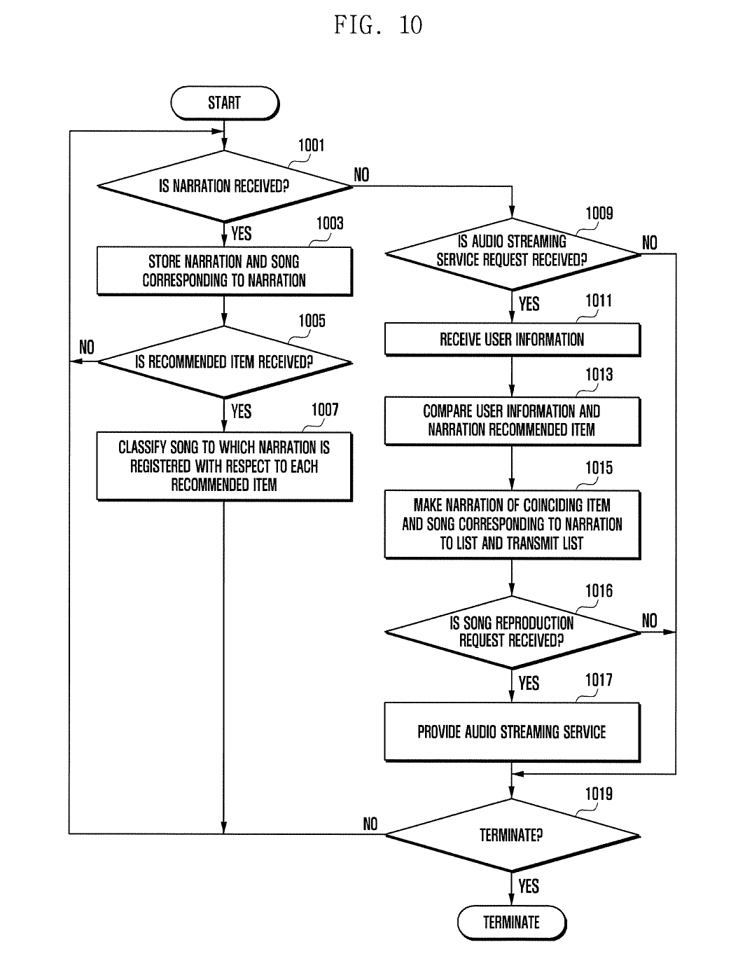

FIG. 10 illustrates a process of an operation of providing contents by the server 200.

Referring to FIG. 10, in operation 1001, the server 200 may determine whether a narration for a song is received from the electronic device 100. When the narration is received, in operation 1003, the server may map the narration and the song corresponding thereto to store the narration and the song. Next, in operation 1005, the server 200 may determine whether to receive a recommended item configured for the song to which the narration is registered. When the recommended item for the song is received, in operation 1007, the server 200 may classify and store the song to which the narration is registered, with respect to each recommended item. When the recommended item for the song is not received, the server 200 may recommend the song, to which the narration is registered, to all of users using the sound source streaming service. When the narration is not received in operation 1001, the server 200 may determine whether an audio streaming service request is received or not, in operation 1009. When the audio streaming service request is generated, in operation 1011, the server 200 may receive user information from the electronic device. Here, the user information may include a location, a time and weather information. Next, the server may compare the received user information with the recommended item of the song to which the narration is registered, in operation 1013, and may transmit, to the electronic device 100, a recommended song list corresponding to an item which is the same in the user information and the recommended item, in operation 1015. Further, in operation 1016, the server 200 may determine whether to receive a reproduction request for the recommended song list. When the reproduction request is received, the server 200 may detect the reproduction request, in operation 1016, and may transmit a song and narration information corresponding to the song, i.e. provide an audio streaming service according to the song list, in operation 1017. Next, in operation 1019, the server 200 may determine whether to detect a termination command. When the termination command is generated, the server 200 may terminate the narration and the audio streaming service.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of providing a content of an electronic device, the method comprising:
when an audio streaming service is requested to a server, transmitting user information of the electronic device;
receiving, from the server, a narration corresponding to the user information, and a recommended song list comprising songs mapped with the narration; and
determining a reproduction priority by analyzing a weighted value of the user information of songs in the received recommended song list, and streaming and reproducing the songs according to the determined reproduction priority.

2. The method of claim 1, wherein the transmitting of the user information further comprises registering the narration comprising a story, an interpretation and an introduction for the songs, and a recommended item for the narration.

3. The method of claim 2, wherein the user information comprises at least one of location information, time information, weather information and a number of times of song reproductions, and
the recommended item comprises at least one of a recommended place, recommended weather, a recommended time, a recommendation person.

4. The method of claim 3, wherein the receiving from the server comprises comparing the user information with the recommended item for the narration.

5. The method of claim 3, wherein the weighted value comprises at least one of a recommendation weighted value, a location weighted value, a target weighted value, a story evaluation weighted value and the number of times of song reproductions within a predetermined time period.

6. The method of claim 3, wherein the reproducing further comprises detecting whether the user information is changed, and
when it is detected that the user information is changed, the recommended song list according to the changed user information is generated again.

7. The method of claim 6, wherein the reproducing further comprises displaying a screen that feeds back the streamed and reproduced song.

8. An electronic device for providing a content, the electronic device comprising:
a touch screen configured to display the audio streaming service screen and audio streaming reproduction screen;
a Global Positioning System (GPS) reception unit configured to detect a location of the electronic device;
an audio processing unit configured to stream and reproduce a song when an audio streaming service is requested; and
a controller configured to control to display the audio streaming service screen on the touch screen, when the audio streaming service is requested to a server, transmit user information of the electronic device, receive a narration corresponding to the user information and a recommended song list including songs mapped with the narration, determine a reproduction priority by analyzing a weighted value of the user information of the songs in the received recommended song list, and stream and reproduce the songs according to the determined reproduction priority.

9. The electronic device of claim 8, wherein the controller is configured to register a narration including a story, an interpretation and an introduction for the song and a recommended item for the narration.

10. The electronic device of claim 9, wherein the controller is configured to compare the user information and the recommended item for the narration, and receive a narration coinciding with the user information and a recommended song list including songs mapped with the narration.

11. The electronic device of claim 10, wherein the controller is configured to determine a song reproduction sequence by analyzing a recommended weighted value, a location weighted value, a target weighted value, a weather weighted value, a story evaluation weighted value and the number of times of reproductions within a predetermined time period.

12. The electronic device of claim 11, wherein, when it is detected that the user information is changed, the controller is configured to perform a control to regenerate the recommended song list according to the changed user information.

13. The electronic device of claim 12, wherein the controller is configured to control the touch screen to display the streamed and reproduced song on a screen which performs feedback.

14. A method of providing a content of a server, the method comprising:
when a narration for a song is registered, registering a recommended item for the narration;
when it is detected that an audio streaming service is requested, receiving user information from an electronic device;
comparing the user information and the recommended item for the narration;
transmitting the narration coinciding with the user information and a recommended song list including songs mapped with the narration; and
when it is detected that reproduction of the songs of the recommended song list is requested, transmitting the songs in the recommended song list in a streaming form to the electronic device.

15. The method of claim 14, wherein the registering further comprises classifying and storing the song to which the narration is registered, with respect to each recommended song item.

16. The method of claim 14, wherein the narration comprises at least one of a story, an interpretation and an introduction for the songs, and a recommended item for the narration.

17. The method of claim 14, wherein the user information comprises at least one of location information, time information, weather information and a number of times of song reproductions.

18. The method of claim 16, wherein the recommended item comprises at least one of a recommended place, recommended weather, a recommended time, a recommendation person.

19. The method of claim 14, further comprising:
responsive to detecting that the user information is changed, changing the recommended song list according to the changed user information.
